(19) United States
(12) Patent Application Publication
(10) Pub. No.: US 2020/0272559 A1
(43) Pub. Date: Aug. 27, 2020

(54) ENHANCING EFFICIENCY IN REGRESSION TESTING OF SOFTWARE APPLICATIONS

(71) Applicant: NIIT Technologies Ltd, New Delhi (IN)

(72) Inventors: Gurpreet Singh Ahluwalia, Bangalore (IN); Jaspreet Singh, Bangalore (IN); Mohit Bardaiyar, Bangalore (IN); Manish Srivastava, Bangalore (IN)

(21) Appl. No.: 16/802,527

(22) Filed: Feb. 26, 2020

(30) Foreign Application Priority Data
Feb. 26, 2019 (IN) 201941007450

(51) Int. Cl. G06F 11/36; G06N 20/00; G06N 5/04

(52) U.S. Cl. CPC G06F 11/3684; G06N 5/04; G06N 20/00

(57) ABSTRACT

An aspect of the present disclosure enhances efficiency in regression testing of software applications by predicting failures of test cases in a proposed test suite. In an embodiment, a system receives as an input multiple test cases of a test suite, where each test case is specified associated with a case identifier, a version number of the test case, a requirement identifier, and a last run status. The system then predicts a set of test cases expected to fail in a next run of the test suite by providing the input to a model implementing machine learning (ML). According to another aspect, the system also predicts a count of defects expected for each requirement in the next run and a severity for each defect.

### PRIORITY CLAIM

The instant patent application is related to and claims priority from the co-pending India provisional patent application entitled, “ENHANCING EFFICIENCY IN REGRESSION TESTING OF SOFTWARE APPLICATIONS”, Serial No.: 201941007450, Filed: 26 Feb. 2019, which is incorporated in its entirety herewith.

### BACKGROUND OF THE DISCLOSURE

### Technical Field

The present invention generally relates to software testing and more specifically to enhancing efficiency in regression testing of software applications.

### Related Art

Software applications are often modified for reasons such as fixing known bugs, performance or feature enhancements, etc., as is well known in the relevant arts. The software application before and after modifications may be referred to as earlier version and later version of the same software application, with the later version of present interest (for testing) being referred to as current version.

Regression testing is performed on a current version of a software application to ensure that the modifications in the current version have not adversely affected features of the earlier version. Typically, several of the test cases executed on earlier versions of the software are executed again on the current version to confirm such an objective.

As regression testing cycles are very long and time-consuming, there is a general need to enhance efficiency in regression testing of software applications.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which failures of test cases in a proposed test suite is predicted according to an aspect of the present disclosure.

FIG. 3 is a block diagram depicting the data flows surrounding a prediction tool in an embodiment.

FIG. 4 is a block diagram depicting the components of a prediction tool in an embodiment.

FIG. 5A depicts a portion of test results indicating details of execution of test cases in one embodiment.

FIGS. 5B and 5C together depicts a portion of processed data generated by prediction tool in one embodiment.

FIGS. 6A and 6B depict portions of the output of a ML model in one embodiment.

FIGS. 7A-7B illustrates the manner in which the predictions for a test suite are provided in one embodiment.

FIG. 8 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure predicts failures of test cases in a proposed test suite. In an embodiment, a system receives as an input multiple test cases of a test suite, where each test case is specified associated with a case identifier, a version number of the test case, a requirement identifier, and a last run status. The system then predicts a set of test cases expected to fail in a next run of the test suite by providing the input to a model implementing machine learning (ML).

In one embodiment, the test cases are organized into test modules, and accordingly the input (provided to the model) includes a test module identifier, a run identifier and a defect count for each test case.

According to another aspect of the present disclosure, the system (noted above) generates additional inputs including a test module performance, a module criticality, a defect continuity, a number of modifications made to the test case after the last run and before the next run, and a number of modifications made to the requirement after the last run and before the next run. The computed additional inputs are also provided to the model for said predicting.

According to one more aspect of the present disclosure, the model (implementing the ML) generates an output comprising a predicted status of each test case in the next run, a count of defects expected for each requirement in the next run and a severity for each defect.

According to yet another aspect of the present disclosure, the system implements the model using a KNN (K Nearest Neighbor) algorithm if the input satisfies a condition, and using a decision tree algorithm otherwise. In one embodiment, the condition is the number of failed test cases is less than 10% of the passed test cases in the last run.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

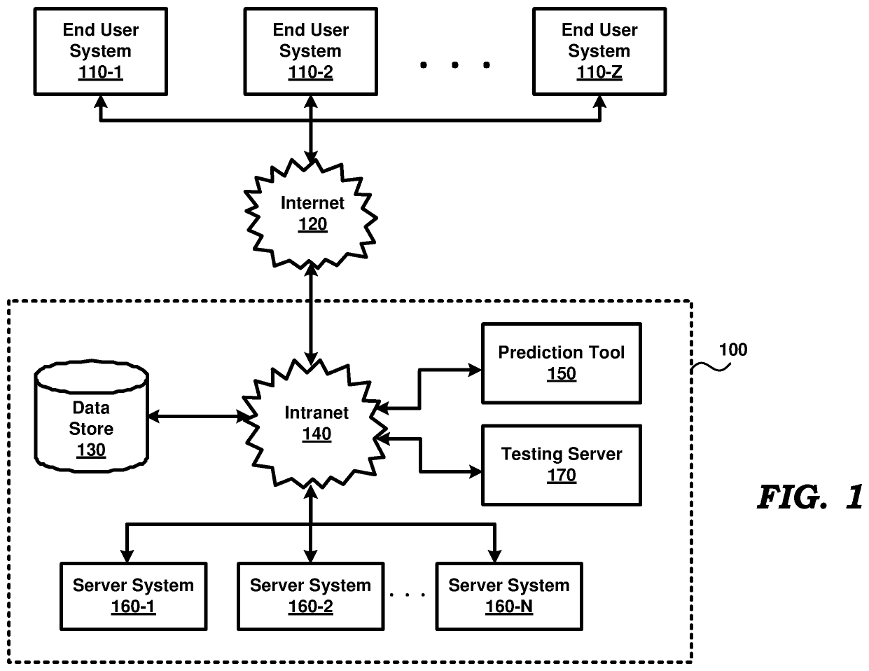

FIG. 1 is a block diagram illustrating an example environment (computing system) in which several aspects of the present disclosure can be implemented. The block diagram is shown containing end-user systems 110-1 to 110-Z (Z representing any natural number), Internet 120, intranet 140, data store 130, prediction tool 150, server systems 160-1 to 160-N (N representing any natural number) and testing server 170. The end-user systems and server systems are collectively referred to by 110 and 160 respectively.

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between data store 130, server systems 160, prediction tool 150 and testing server 170, all provided within an enterprise (100 as indicated by the dotted boundary). Internet 120 extends the connectivity of these (and other systems of the enterprise) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies the target application, the packet may be said to be directed to such application as well.

Data store 130 represents a non-volatile (persistent) storage facilitating storage and retrieval of a collection of data by (enterprise) applications executing in server system 160 (and also prediction tool 150 and testing server 170). Data store 130 may be implemented as a database server using relational database technologies and accordingly provide storage and retrieval of data using structured queries such as SQL (Structured Query Language). Alternatively, data store 130 may be implemented as a file server providing storage and retrieval of data in the form of files organized as one or more directories, as is well known in the relevant arts.

Each of end-user systems 110 represents a system such as a personal computer, workstation, mobile device, computing tablet etc., used by users to generate client requests directed to software applications executing in server systems 160. The client requests may be generated using appropriate user interfaces (e.g., web pages provided by an application executing in server systems, a native user interface provided by a portion of the application downloaded from server systems, etc.)

In general, an end-user system requests an software application for performing desired tasks and receives the corresponding responses (e.g., web pages) containing the results of performance of the requested tasks. The web pages/responses may then be presented to the user by client applications such as a browser. Each client request is sent in the form of an IP packet directed to the desired server system or application, with the IP packet including data identifying the desired tasks in the payload portion.

Each of server systems 160 represents a server, such as a web/application server, executing software applications capable of performing tasks requested by users using one of end-user systems 110. A server system may use data stored internally (for example, in a non-volatile storage/hard disk within the server system), external data (e.g., maintained in data store 130) and/or data received from external sources (e.g., from the user) in performing the requested tasks. The server system then sends the result of performance of the tasks to the requesting end-user system (one of 110-1 to 110-Z). The results may be accompanied by specific user interfaces (e.g., web pages) for displaying the results to the requesting user.

It may be appreciated that different versions of a software application may be executing in server systems 160. For example, both earlier versions and later/current versions of the software application may be executing in different server systems 160. It may be desirable that the current versions of the software application be regression tested to ensure that modifications in the current version have not adversely affected features of the earlier version.

Testing server 170 facilitates regression testing of software applications executing in server systems 160. As is well known, regression testing is performed by executing again several of the test cases (previously executed on earlier versions of the software) on the current version. Execution of a test case typically entails providing inputs (specified by the test case) to software application, receiving the corresponding output from the software application, and comparing the received output with an expected output (specified by the test case).

Thus, the test results indicate whether or not the respective test cases have passed. A test case is said to have passed if the result of execution of a test case matches the expected result specified in or associated with the test case in the test suite, and failed when there is a mismatch. In an embodiment, the software application is characterized as being designed to meet several ‘requirements’ (often a utilitarian aspect), and a set of test cases may be associated with each such requirement. A defect is said to be present when a corresponding requirement is not met due to the failure of at least one associated test case.

In the following disclosure, it is assumed that the test cases are maintained in data store 130, organized into one or more test modules and test suites. Data store 130 may also maintain the result of execution of test cases for each version, test cycles, etc. The test cases and respective test results stored in data store 130 may be managed using test management tools such as HP Quality Center, Bugzilla Testopia, etc.

Testing server 170 accordingly retrieves regression test cases (test suite) for an iteration from data store 130, executes the test cases on the current version of a software application executing (respective instances) on one or more server systems 160, and stores the test results back to the data store 130. Testing server 170 may be further designed to support execution of several test cases in a short duration. The test cases of a test suite may be divided into batches. Each batch of test cases may be executed to completion before starting execution of a next batch. Test cases within a batch can be executed in parallel on several server systems 160.

As noted in the Background section, it may be desirable that to enhance the efficiency in regression testing of software applications, for example, reduce the time for executing of a test suite, etc.

Prediction tool 150, provided according to several aspects of the present disclosure, enhances efficiency in regression testing of software applications by predicting failures of test cases within a test suite. The manner in which prediction tool 150 predicts failures of test cases is described below with examples.

### 3. Predicting Failures of Test Cases

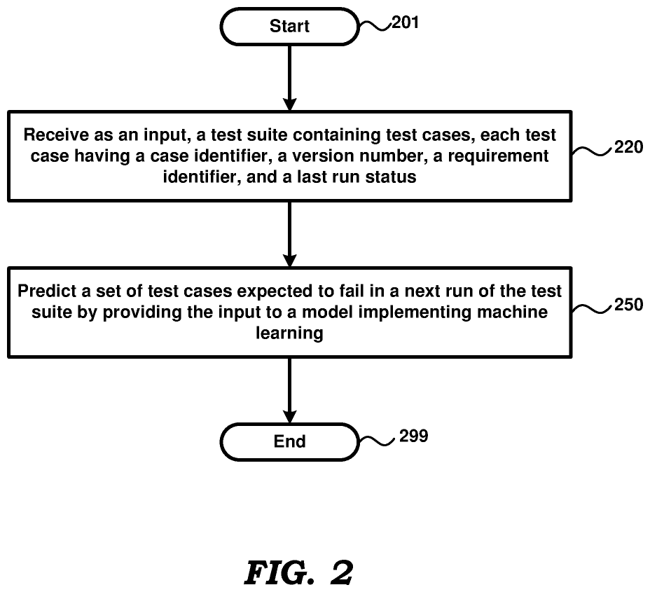

FIG. 2 is a flow chart illustrating the manner in which failures of test cases in a proposed test suite is predicted according to an aspect of the present disclosure. The flowchart is described with respect to prediction tool 150 of FIG. 1 merely for illustration. However, many of the features can be implemented in other environments also without departing from the scope and spirit of several aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 220.

In step 220, prediction tool 150 receives as an input multiple test cases of a test suite, where each test case is specified associated with a case identifier, a version number of the test case, a requirement identifier, and a last run status. In one embodiment, the test cases are organized into test modules, and accordingly the input includes a test module identifier, a run identifier and a defect count for each test case.

According to an aspect, prediction tool 150 generates additional inputs including a test module performance, a module criticality, a defect continuity, a number of modifications made to the test case after the last run and before the next run, and a number of modifications made to the requirement after the last run and before the next run based on the input received by prediction tool 150.

In step 250, prediction tool 150 predicts a set of test cases (of the test suite) that are expected to fail in a next run of the test suite by providing the input to a model implementing machine learning (ML). The additional inputs are computed are also provided to the model.

According to an aspect, prediction tool 150 implements the model using a KNN (K Nearest Neighbor) algorithm if the input satisfies a condition, and using a decision tree algorithm otherwise. In one embodiment, the condition is the number of failed test cases is less than 10% of the passed test cases in the last run.

In one embodiment, the ML model generates an output comprising a predicted status (pass or fail) of each test case in the next run, a count of defects expected for a requirement in the next run and a severity for each defect. The flow chart ends in step 299.

It may be appreciated that the prediction of failure of test cases, software defects and the severity of the defects can be used to obtain various efficiencies in regression testing. For example, such prediction can be used in scheduling of test cases of the test suite whereby test cases likely to fail may be scheduled in earlier batches such that the defects are quickly identified and fixed before potentially continuing testing in a next iteration. The scheduling of the test cases may result in reducing the time taken to execute a test suite.

The manner in which prediction tool 150 predicts failure of test cases according to FIG. 2 is illustrated below with examples.

### 4. Example Illustration

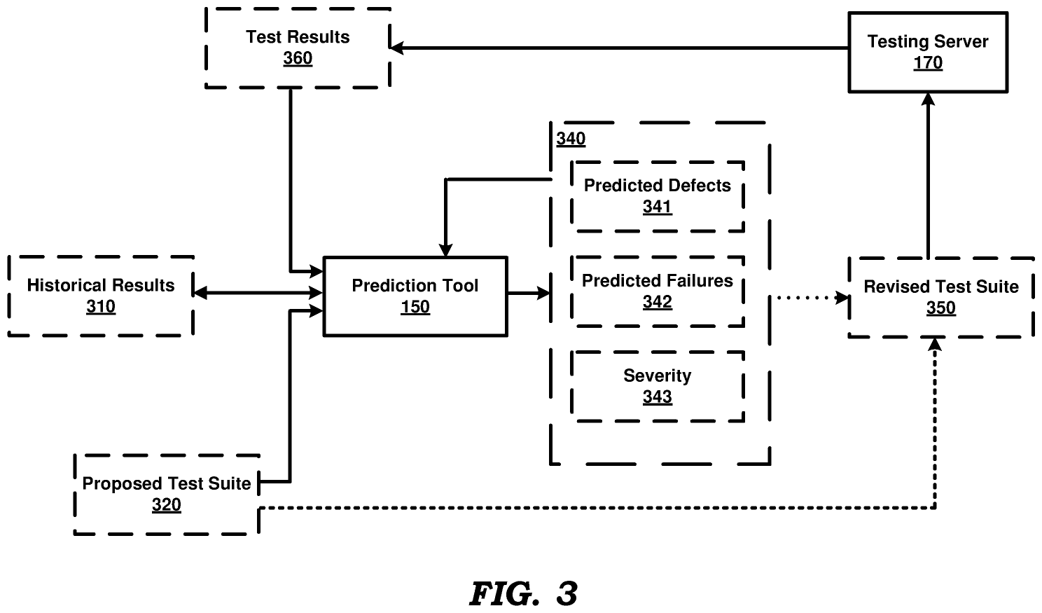

FIGS. 3, 4, 5A-5C, 6A-6B and 7A-7B together illustrate the manner in which efficiency in regression testing of software applications is enhanced in one embodiment. Each of the Figures is described in detail below.

FIG. 3 is a block diagram depicting the data flows surrounding a prediction tool in an embodiment. The block diagram is shown containing historical results 310, proposed test suite 320, predicted data 340, revised test suite 350 and test results 360. The processing blocks and their input/output data flows are shown in solid lines, while data blocks and usage of such blocks by human effort are shown as dotted lines. Each of the blocks is described in detail below.

Proposed test suite 320 represents a collection of test cases that a testing organization may wish to perform/execute against the current versions of the software application (executing in server systems 160). In one embodiment, the test cases are organized into test modules.

Revised test suite 350 includes the tests cases from proposed test suite 320 that are revised (potentially by testing administrators) based on predicted data 340 generated by prediction tool 150. Such revision may entail changing/editing the content of the test case such as inputs to the software application, expected results, etc. Besides the revised test cases, revised test suite 350 includes all the other (non-revised) test cases from proposed test suite 320.

In an embodiment, the revisions are to reorder the execution sequence of test cases in proposed test suite 320 such that test cases likely to fail are executed sooner (i.e., in the earlier batches executed) in revised test suite 350. As noted above, such a revision in the test suite facilitates defects to be quickly identified and fixed before potentially continuing testing in a next iteration, thereby reducing the time taken to execute a test suite (320).

Testing server 170 executes revised test suite 350 to generate test results 360. The execution of revised test suite 350 entails executing the test cases in batches, potentially in parallel on several server systems 160. Test results 360 indicate the status (passed or failed) of the test cases contained in revised test suite 350. The results may be status for a single run (execution of the all the test cases) of revised test suite 350 or for multiple runs performed for the same revised test suite 350.

Predicted data 340 is shown containing predicted failures 342, indicating the specific ones of test cases of proposed test suite 320 that are likely to fail and the ones that may not fail (match of expected result with actual result). Predicted defects 341 represents the requirements that are derived to be failed based on the data in block 342. In other words, based on a mapping available of a set of test cases testing each requirement, requirements likely to fail (in tests) and the number of sets of test cases likely to fail for each requirement may be represented in block 341 as predicted defects.

Severity 343 indicates the severity (e.g. High, Medium, Low) of each of predicted defects 341, and may be used as the basis for fixing the predicted defects. For example, defects with higher severity (e.g. High) may be fixed first as compared to defects with lower severity (e.g. Medium and Low).

Historical results 310 indicate various test suites and corresponding test cases executed, the status of the test cases during each execution, etc. Historical results 310 may be formed/added by operation of prediction tool 150, and continued to be used in further iterations of testing of the current version of the software application.

Alternatively, some of the parts of historical results 310 can be saved by testing server 170 and prediction tool 150 can use such data as well. Historical results 310 may also contain data indicating the prior failures and accuracy of predictions.

Prediction tool 150 generates predicted data 340 for proposed test suite 320 based on historical results 310 and proposed test suite 320. Both test results 360 and prediction data 340 from a prior iteration may also be considered historical data 310, though shown as separate blocks. Prediction tool 150 may use machine learning tools for the predictions and the details of an example embodiment are described below in further detail.

### 5. Prediction Tool

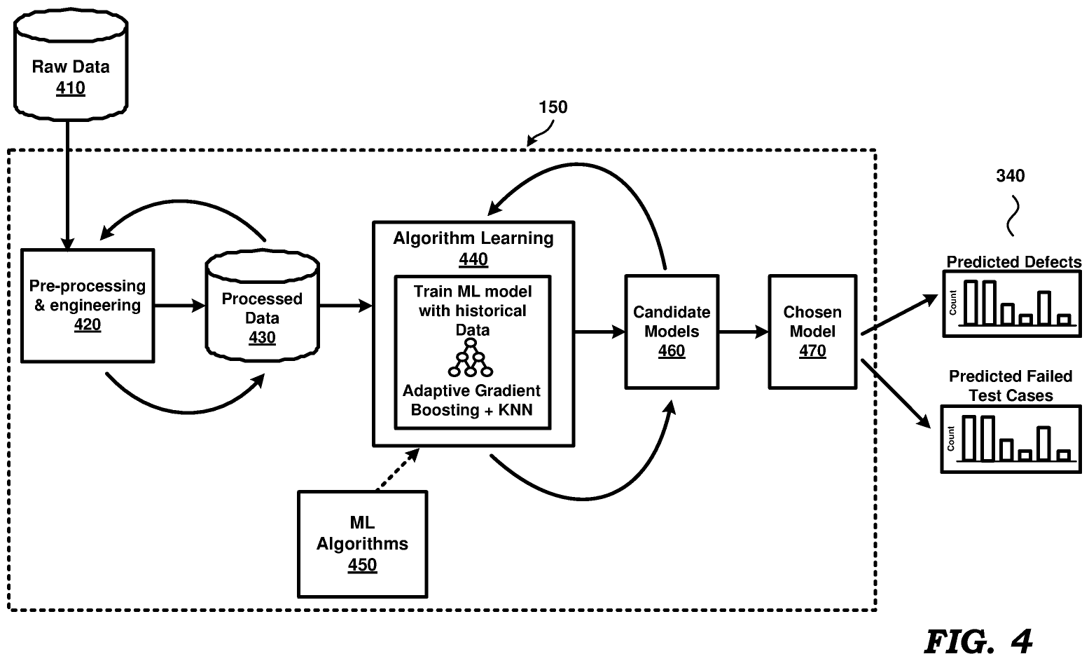

FIG. 4 is a block diagram depicting the components of prediction tool 150 in an embodiment. The block diagram is shown containing raw data 410, pre-processing & engineering (PPE) 420, processed data 430, algorithm learning 440, Machine Learning (ML) algorithms 450, candidate model 460, chosen model 470. Each of the blocks is described in detail below.

Raw data 410 includes historical results 310, test results 360 and details of proposed test suite 320 processed by prediction tool 150. Some of the details available in raw data 410 for each test case is shown in the below table:

| Name | Description |
|---|---|
| Feature Details | Feature Name & Feature ID |
| Test Case Details | Test Name & Test ID |
| Execution Status | Execution Date, Execution result |
| Defect info | Number of defects against test cases |
| Version Details | Change in version or test cases |
| Severity Details | Severity defect |

Raw data 410 thus may include feature (or requirement) details (including name and identifier), test case details, execution status (date executed and failed/passed status), defect information (from 342), version details (indicating the version level of each test case), and severity details (representing the seriousness if a requirement is defective). It may be noted that raw data 410 includes historical results 410 from previous iterations of testing of current and previous versions of the software.

PPE 420 processes raw data 410 in potentially multiple iterations by applying domain knowledge of the data and creating features to generate processed data 430, as relevant to processing by subsequent blocks of FIG. 4 to make machine learning algorithms to work efficiently. Some of the additional data that may be created/computed by PPE 420 is shown in the below table:

| Variable Type | Name | Description |
|---|---|---|
| Independent | Feature Details | Feature Name & Feature ID |
| Variables | Test Case Details | Test Name & Test ID |
| | Gap_in_last_Failure | Number of days since the test case |
| | | failed last |
| | Avg. Rolling failures | Qualification of past performance |
| | | feature on test failures |
| | Failure Continuity | Continuity factor of tests cases |
| | | failure in last executions |
| | Model Criticality | Number of test cases under a feature |
| | | in a specified month |
| | Number of runs | Number of cycle runs for test case |
| | Number of modifications | Number of modifications made in |
| | | test cases and features |
| | Feature Size | Number of test cases under a feature |
| | | in a specified month |
| | Gap in execution | Gap of days between last execution |
| | | and current execution |
| Response | Pass/Fail Prediction | Prediction one test cases being |
| Variables | | passed or failed |
| | Requirement wise Number | Prediction on Number of test cases |
| | of Defect | |
| | Requirement wise DWS | Defect weighted score (DWS) for |
| | | each requirement |

In one embodiment, PPE 320 also genreates other independent variables such as a test module performance, a module criticality, a defect continuity, a number of modifications made to the test case after the last run and before the next run, and a number of modifications made to the requirement after the last run and before the next run.

Processed data 430 includes portions of raw data 410 and also data processed by PPE 320 (such as the independent and response variable noted above). Processed data 430 may be maintained in any format convenient for applying machine learning approaches to the data.

ML algorithms 450 represent various approaches/algorithms that can be used as a basis for machine learning. In an embodiment, ML algorithms 450 include KNN (K Nearest Neighbor) and Decision Tree. Various other machine learning approaches applicable to the corresponding domain can be employed, as will be apparent to skilled practitioners, by reading the disclosure provided herein. In an embodiment, supervised machine learning approaches are used.

Algorithm learning 440 identifies the best possible ML algorithm based on processed data 430 generated by PPE 420. This is dependent on the factors like data imbalance. For example, KNN may be selected when number of failed test cases is less than 10% of the passed test cases (in the previous iteration), and Decision Tree is selected otherwise.

Candidate models 460 represent the various models that may be generated by algorithm learning 440 based on the selected machine learning approach/algorithm and processed data 430. Algorithm learning 440 then selects one of such generated candidate models 460 as chosen model 470, based on variables such as associated confidence value, as is well known in machine learning approaches.

Chosen model 470 contains the information on predicted failures 342 and the corresponding information can be suitably extracted. Predicted defects 341 can be generated based on user data indicating the mapping of test cases to respective requirements, in a known way. Based on the piloting done on several real world testing projects, the accuracy of predicted defects 341 and predicted failures 342 is observed to be between 70-80% varying across different iterations of testing.

The description is continued with respect to details of various input and output data to prediction tool 150 in an embodiment.

### 6. Input and Output Data of Prediction Tool

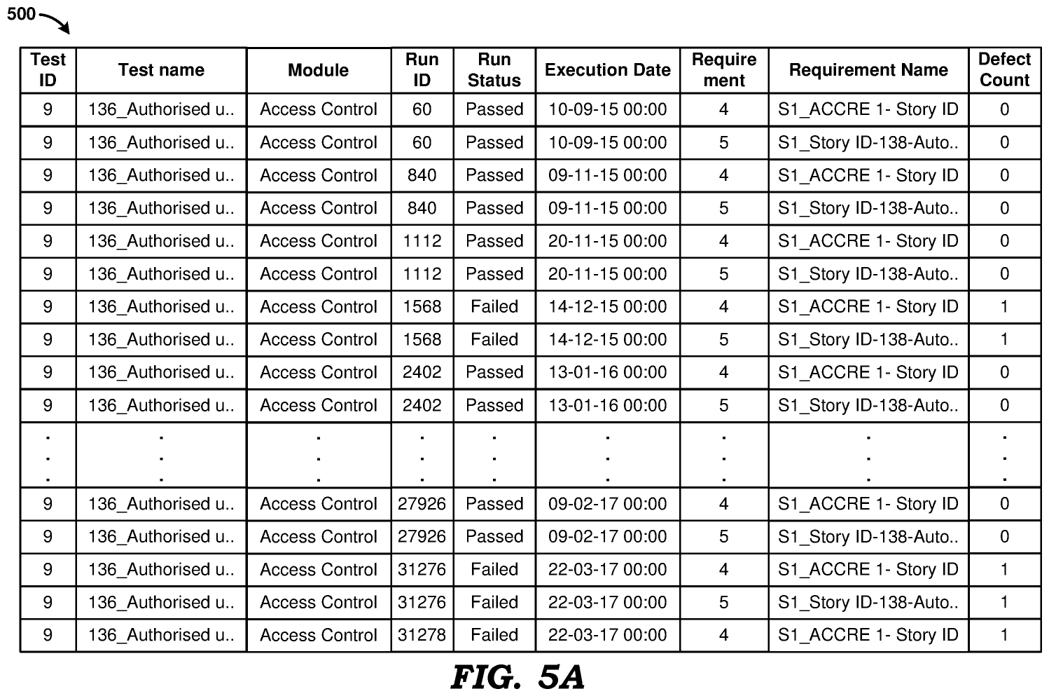

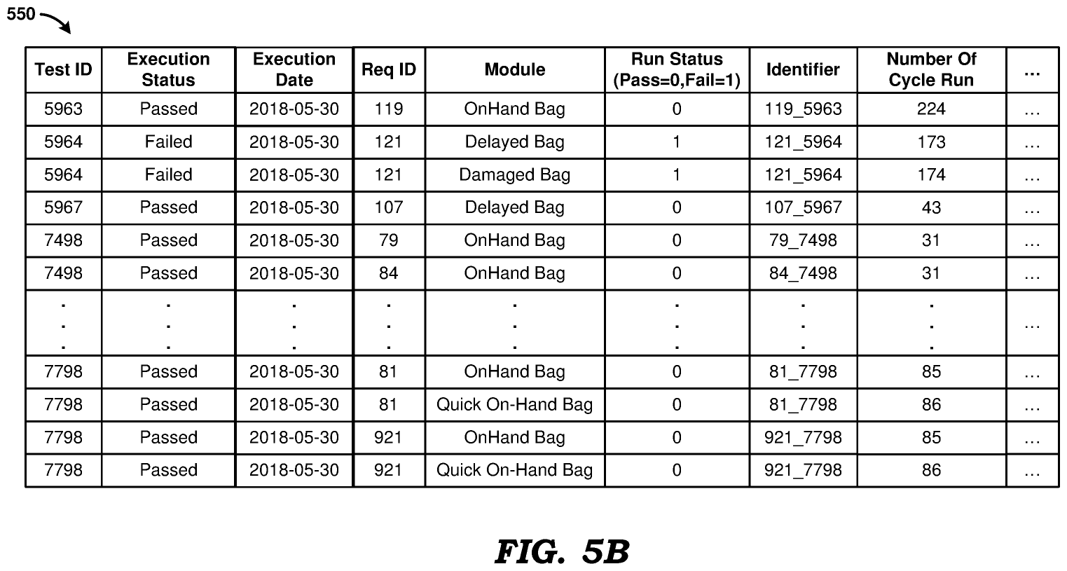

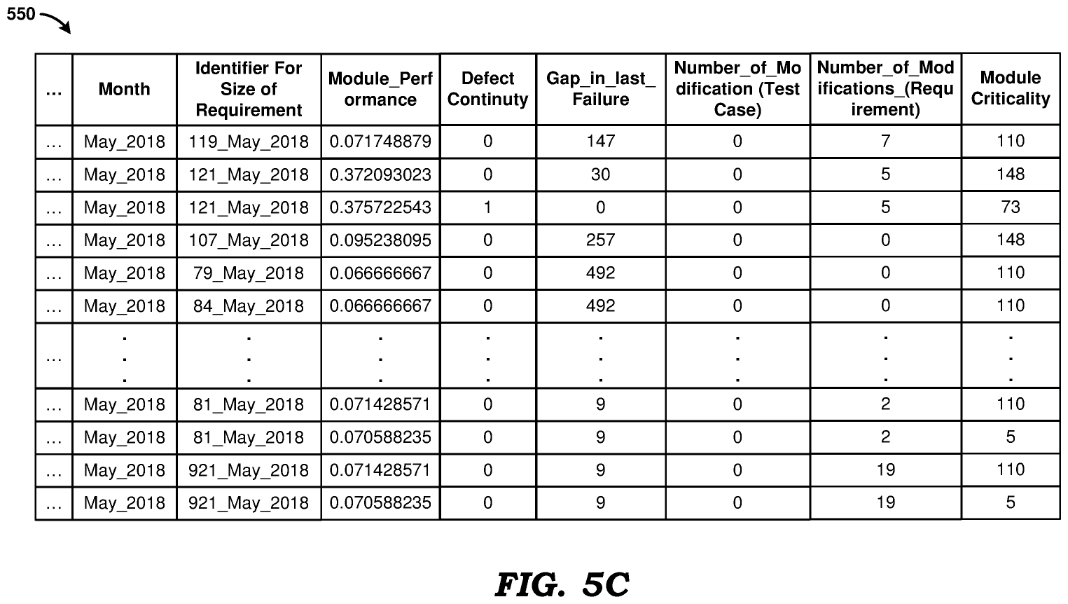

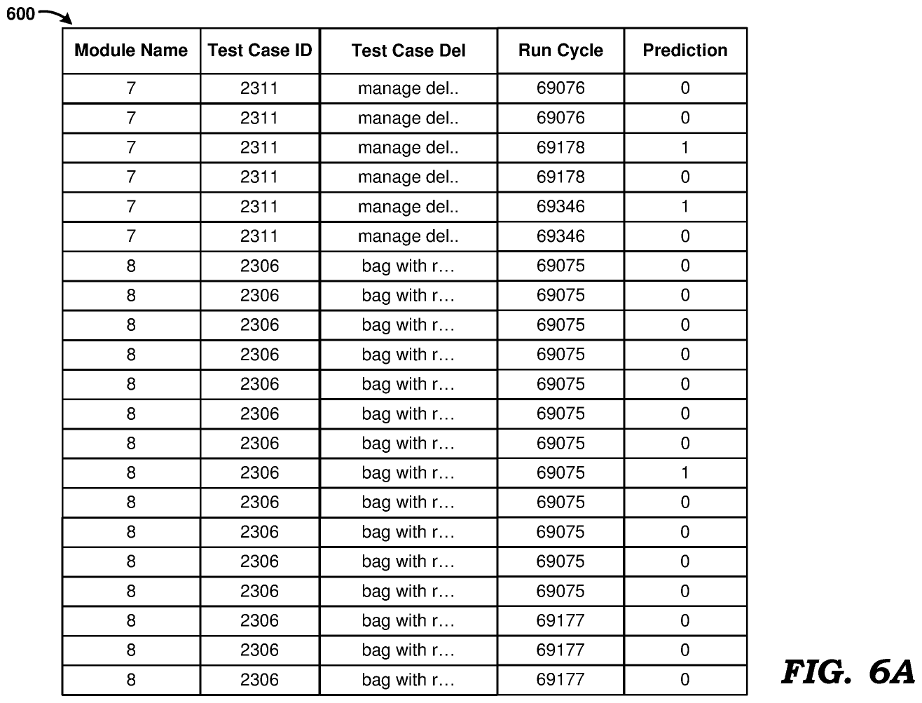

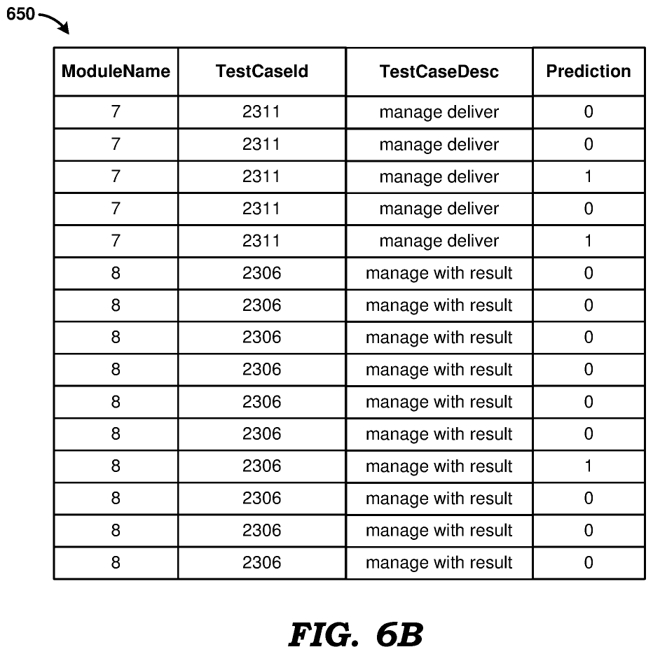

FIG. 5A depicts a portion of test results indicating details of execution of test cases in one embodiment. For illustration, the data of FIGS. 5A-5C and 6A-6B are assumed to be maintained in the form of tables in data store 130. However, in alternative embodiments, the data may be maintained according to other data formats (such as files according to extensible markup language (XML), etc.) and/or using other data structures (such as lists, trees, etc.), as will be apparent to one skilled in the relevant arts by reading the disclosure herein.

Table 500 depicts a portion of the test results that also forms part of raw data 410 in an embodiment. Each row of table 500 corresponds to execution of a test case and the data corresponding to same test case is shown in all rows for illustration. It may be readily observed that information on the same test case is repeated in multiple rows if execution of the same test case tests multiple requirements.

The columns of table 500 specify the details of execution of the test cases. In particular, column “Test ID” indicates the unique identifier for a test case (row), while column “Test Name” indicates the name of the test case. Column “Module” indicates name of the test module containing the corresponding test case. The module name follows the conventional hierarchical structure of Module to Test Name followed by QA teams in testing server 170. Column “Run ID” indicates the test case execution run cycle. Each test case is executed multiple times based on the number of test executions. Column “Run Status” indicates execution status (“Passed” or “Failed”) for each Run ID. Column “Execution Date” indicates the date (and time) at which the test case was executed.

Column “Requirement ID” indicates the functional Requirement ID to which the test case belongs. The requirement may be already mapped to the test case in the scenario that both the fields are coming from a test management tool or correlation data may be provided if these columns are extracted from a requirement management tool, as will be apparent to one skilled in the relevant arts. Column “Requirement Name” indicates the name of the requirement to which the test case belongs. Column “Defect Count” indicates the number of defects raised by the test case execution. Failure of execution is indicated by 1 and success by 0 to indicate the contribution to the defect count corresponding to the specific combination represented by the test case (row).

It may be appreciated that table 500 is provided as part of raw data 410 to PPE 420, which in turn processes the raw data and generates processed data 430. Some of the portions of processed data 430 are described in detail below.

FIGS. 5B and 5C together depicts a portion of processed data (430) generated by prediction tool (150) in one embodiment. In particular, table 550 (of FIGS. 5B and 5C) is formed by first pre-processing raw data similar to table 500 and then feature engineering where new features (columns) are derived (from raw data columns) that are influential and can help in improving overall accuracy of prediction.

Pre-processing steps may include handling inconsistent formatting where data not having expected format or value are corrected to a consistent format, handling imbalanced data by using over or under sampling data analysis techniques by adjusting class distribution of the dataset, etc.

Table 550 represents the details of processed data 330 in an embodiment. Assuming table 500 contains many rows corresponding to execution of test cases during many iterations, each row of table 550 summarizes a portion of such data as a suitable input for machine learning. It may be readily observed that some of the columns of table 550 are same as that in table 500 and accordingly their description is repeated here for conciseness.

Some of the columns of table 550 represented additional features generated/computed by prediction tool 150 (in particular PPE 420). For example, column “Module Performance” indicates the average failure rate for the test cases in total runs. Column “Defect Continuity” indicates a count of consecutive failures of test case before the current execution, that is, if the test case has been consecutively failing in last runs (Count of consecutive failures). Column “Gap in last Failure” indicates the gap in days between current and last execution.

Column “Number of Modifications (Test Case)” indicates the number of times the modifications are made in test cases after last run and before current run. This computed value is used to compute changes in software requirement for the test cycle. Column “Number of Modifications (Requirement)” indicates the number of modifications made to the test cases under a specific requirement after last run and before the current run. This computed value is used to compute changes in software requirement for the test cycle.

Column “Module Criticality” indicates the critically of module based on its size (e.g. the total number of test cases in the module). Alternately, the module criticality may be input from a requirement or test management tool in terms of function size against each requirement which makes this feature more accurate.

Thus, prediction tool 150 generates additional inputs for selection and implementation of a ML model. As noted above, chosen model 470 generates an output comprising a predicted status of each test case in said next run, a count of defects expected for each requirement in said next run and a severity for each defect. Some sample portions of the output of the ML model is described in detail below.

FIGS. 6A and 6B depict portions of the output of a ML model in one embodiment. Specifically tables 600 and 650 are respective portions of output of chosen model 470, which can be further processed to generate predicted data 340 in an embodiment. In each of tables 600 and 650, each row represents a prediction for a test case for a run-cycle. As may be appreciated, multiple rows are shown for the same test case. Run-cycle is an engineered feature which, for every test case, starts with 1 and increments by 1 for each test run. Run-cycle is used for test case performance calculation.

According to an aspect, prediction tool 150 also displays a user interface that enables a user to view the predicted failures of test cases and predicted software defects. Some sample user interfaces that may be provided by prediction tool 150 are described in detail below.

### 7. Sample User Interfaces

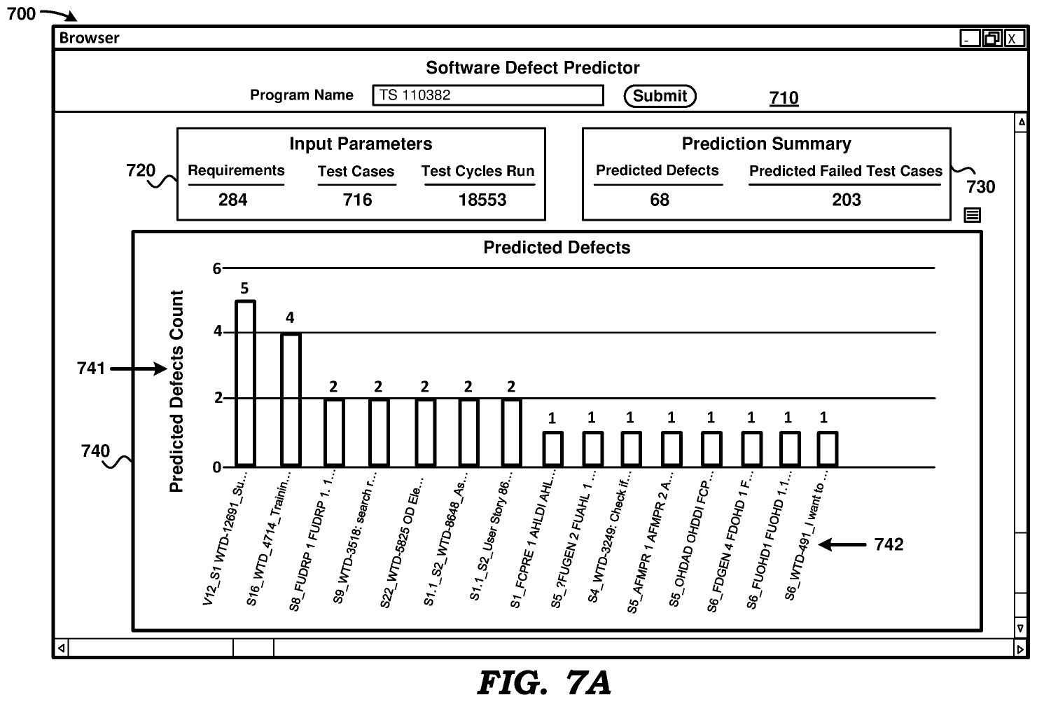

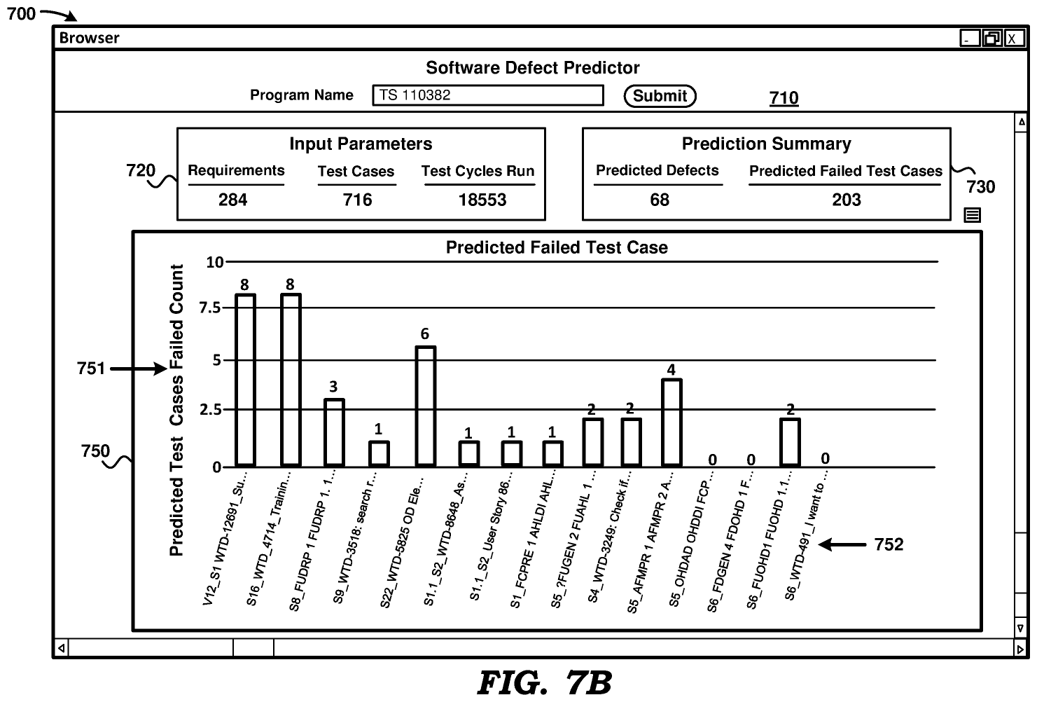

FIGS. 7A-7B illustrates the manner in which the predictions for a test suite are provided in one embodiment. Display area 700 represents a portion of a user interface displayed on a display unit (not shown) associated with one of end-user systems 110. In one embodiment, display area 700 corresponds to a web page rendered by a browser executing on the end user system. Web pages are provided by prediction tool 150 in response to a user/administrator sending appropriate requests (for example, by specifying corresponding URLs in the address bar) using the browser.

Referring to FIG. 7A, display area 710 enables a user to enter the name of a program (name or identifier of a proposed test suite 320) sought to be predicted. Upon the user selecting the “Submit” button in display area 710, prediction tool 150 retrieves (from data store 130) the details of the specified test suite (“TS 110382”) such as a case identifier, a version number of the test case, a requirement identifier, and a last run status for each test case in the specified test suite, and predicts the test case failures and defects for the specified test suite.

Display area 720 indicates the number of requirements, test cases and test cycles run identified by prediction tool 150 based on details of the specified test suite. Display area 730 indicates the prediction summary, in particular, the number of predicted defects and the number of predicted failed test cases.

Display area 740 depicts a graph of the predicted defects for the test cases in proposed test suite 320. X-axis 741 indicates the requirement ID corresponding to the different requirements specified in the test suite, while Y-axis 742 indicates the number of defects predicted for the corresponding requirement.

Referring to FIG. 7B, display area 750 depicts a graph of the predicted failed test cases in proposed test suite 320. X-axis 751 indicates the requirement ID corresponding to the different requirements specified in the test suite, while Y-axis 752 indicates the number of test cases predicted for the corresponding requirement.

From the above results, the requirements where more defects and correspondingly more test cases are expected to fail are predicted, which aid the testing organization to appropriately formulate revised test suite 350. However, the predictions performed according to aspects of the present disclosure can be used for other purposes as well, as will be apparent to one skilled in the relevant arts by reading the disclosure provided herein.

It should be appreciated that the features described above can be implemented in various embodiments as a desired combination of one or more of hardware, software, and firmware. The description is continued with respect to an embodiment in which various features are operative when the software instructions described above are executed.

### 8. Digital Processing System

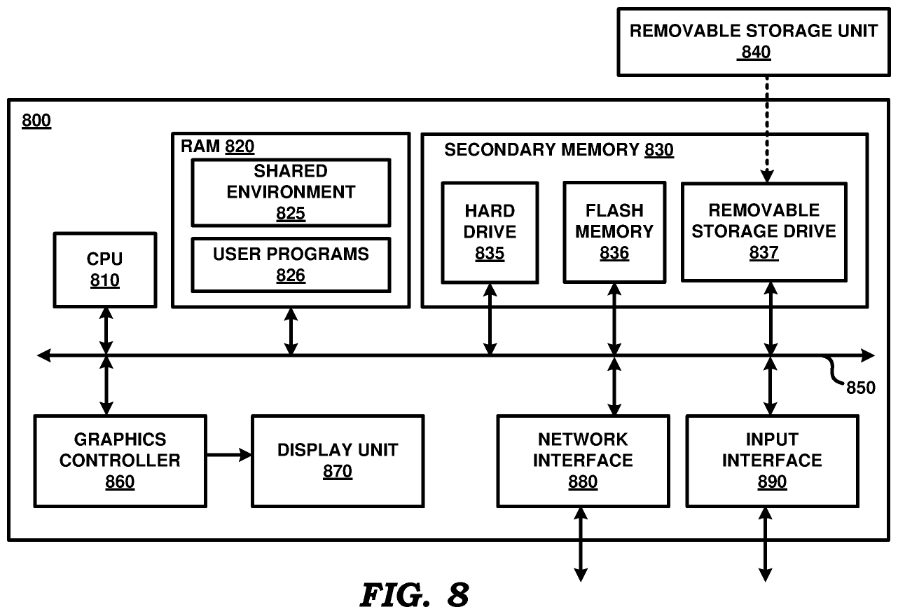

FIG. 8 is a block diagram illustrating the details of digital processing system 800 in which various aspects of the present disclosure are operative by execution of appropriate executable modules. Digital processing system 800 corresponds to prediction tool 150.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and user programs 826. Shared environment 825 includes operating systems, device drivers, virtual machines, etc., which provide a (common) run time environment for execution of user programs 826.

Graphics controller 860 generates display signals (e.g., in RGB format) to display unit 870 based on data/instructions received from CPU 810. Display unit 870 contains a display screen to display the images defined by the display signals (e.g. portions of the user interfaces of FIGS. 7A-7B). Input interface 890 may correspond to a keyboard and a pointing device (e.g., touch-pad, mouse) and may be used to provide appropriate inputs (e.g. in the portions of the user interfaces of FIGS. 7A-7B). Network interface 880 provides connectivity to a network (e.g., using Internet Protocol), and may be used to communicate with other systems (of FIG. 1) connected to the network.

Secondary memory 830 may contain hard drive 835, flash memory 836, and removable storage drive 837. Secondary memory 830 may store the data (e.g. portions of the data shown in FIGS. 5A-5C and 6A-6B) and software instructions (e.g. to implement the steps of FIG. 2, blocks of FIGS. 3 and 4), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method of enhancing efficiency in regression testing of software applications, the method comprising:
receiving as an input a plurality of test cases of a test suite, wherein each test case is specified associated with a case identifier, a version number of the test case, a requirement identifier, and a last run status; and
predicting a set of test cases of said plurality of test cases expected to fail in a next run of said test suite by providing said input to a model implementing machine learning.

2. The method of claim 1, wherein said plurality of test cases are organized into a plurality of test modules, wherein said input further comprises a test module identifier, a run identifier and a defect count for each test case.

3. The method of claim 2, further comprising generating additional inputs comprising a test module performance, a module criticality, a defect continuity, a number of modifications made to the test case after said last run and before said next run, and a number of modifications made to the requirement after said last run and before said next run,
wherein said additional inputs are also provided to said model for said predicting.

4. The method of claim 1, wherein said model generates an output comprising a predicted status of each test case in said next run, a count of defects expected for each requirement in said next run and a severity for each defect.

5. The method of claim 4, further comprising displaying graphs indicating (A) a count of test cases of said test suite predicted to fail as against requirements, and (B) said count of the defects expected for each requirement.

6. The method of claim 1, further comprising implementing said model using a KNN (K Nearest Neighbor) algorithm if said input satisfies a condition, and using a decision tree algorithm otherwise.

7. The method of claim 5, wherein said condition is the number of failed test cases is less than 10% of the passed test cases in said last run.

8. A non-transitory machine readable medium storing one or more sequences of instructions for enhancing efficiency in regression testing of software applications, wherein execution of said one or more instructions by one or more processors contained in said system causes said system to perform the actions of:
receiving as an input a plurality of test cases of a test suite, wherein each test case is specified associated with a case identifier, a version number of the test case, a requirement identifier, and a last run status; and
predicting a set of test cases of said plurality of test cases expected to fail in a next run of said test suite by providing said input to a model implementing machine learning.

9. The non-transitory machine readable medium of claim 8, wherein said plurality of test cases are organized into a plurality of test modules, wherein said input further comprises a test module identifier, a run identifier and a defect count for each test case.

10. The non-transitory machine readable medium of claim 9, further comprising one or more instructions for generating additional inputs comprising a test module performance, a module criticality, a defect continuity, a number of modifications made to the test case after said last run and before said next run, and a number of modifications made to the requirement after said last run and before said next run,
wherein said additional inputs are also provided to said model for said predicting.

11. The non-transitory machine readable medium of claim 8, wherein said model generates an output comprising a predicted status of each test case in said next run, a count of defects expected for each requirement in said next run and a severity for each defect.

12. The non-transitory machine readable medium of claim 11, further comprising one or more instructions for displaying graphs indicating (A) a count of test cases of said test suite predicted to fail as against requirements, and (B) said count of the defects expected for each requirement.

13. The non-transitory machine readable medium of claim 8, further comprising one or more instructions for implementing said model using a KNN (K Nearest Neighbor) algorithm if said input satisfies a condition, and using a decision tree algorithm otherwise.

14. The non-transitory machine readable medium of claim 13, wherein said condition is the number of failed test cases is less than 10% of the passed test cases in said last run.

15. A digital processing system comprising:
a processor;
a random access memory (RAM);
a machine readable medium to store one or more instructions, which when retrieved into said RAM and executed by said processor causes said digital processing system to enhance efficiency in regression testing of software applications, said digital processing system performing the actions of:
receiving as an input a plurality of test cases of a test suite, wherein each test case is specified associated with a case identifier, a version number of the test case, a requirement identifier, and a last run status; and
predicting a set of test cases of said plurality of test cases expected to fail in a next run of said test suite by providing said input to a model implementing machine learning.

16. The digital processing system of claim 15, wherein said plurality of test cases are organized into a plurality of test modules, wherein said input further comprises a test module identifier, a run identifier and a defect count for each test case.

17. The digital processing system of claim 16, further performing the actions of generating additional inputs comprising a test module performance, a module criticality, a defect continuity, a number of modifications made to the test case after said last run and before said next run, and a number of modifications made to the requirement after said last run and before said next run,
wherein said additional inputs are also provided to said model for said predicting.

18. The digital processing system of claim 15, wherein said model generates an output comprising a predicted status of each test case in said next run, a count of defects expected for each requirement in said next run and a severity for each defect,
said digital processing system further performing the actions of displaying graphs indicating (A) a count of test cases of said test suite predicted to fail as against requirements, and (B) said count of the defects expected for each requirement.

19. The digital processing system of claim 15, further performing the actions of implementing said model using a KNN (K Nearest Neighbor) algorithm if said input satisfies a condition, and using a decision tree algorithm otherwise.

20. The digital processing system of claim 19, wherein said condition is the number of failed test cases is less than 10% of the passed test cases in said last run.
